(19) United States
(12) Patent Application Publication
(10) Pub. No.: US 2026/0187443 A1
(43) Pub. Date: Jul. 2, 2026

(54) DETECTING SENSITIVE INFORMATION VIA MACHINE LEARNING AGENTS

(71) Applicant: International Business Machines Corporation, Armonk, NY (US)

(72) Inventors: Bo Wen, Chappaqua, NY (US); Chen Wang, Chappaqua, NY (US); Huamin Chen, Newton, MA (US); Takashi Itoh, Tokyo (JP)

(21) Appl. No.: 19/007,750

(22) Filed: Jan. 2, 2025

(51) Int. Cl. G06N 3/08

(52) U.S. Cl. CPC G06N 3/08

(57) ABSTRACT

According to an embodiment of the present invention, a computer system detects, via a plurality of models, sensitive information within a dataset. The plurality of models includes detection models each configured for detecting the sensitive information within the dataset based on a different detection technique and evaluation models configured for producing evaluations of the detection models with respect to detecting the sensitive information. A resulting detection is generated from determinations of the detection models based on a consensus of the evaluations of the detection models. Performance of the plurality of models is evaluated and modifications for the plurality of models are determined based on the performance. The plurality of models are adjusted for detection of the sensitive information in accordance with the modifications. Embodiments of the present invention further include a method and computer program product for detecting sensitive information in substantially the same manner described above.

### BACKGROUND

### 1. Technical Field

Present invention embodiments relate to data security, and more specifically, to detecting sensitive information (e.g., protected health information (PHI), personally identifiable information (PII), etc.) in medical or other records using an artificial intelligence (AI)/machine learning multi-agent architecture.

### 2. Discussion of the Related Art

Utilizing medical records for research while protecting patient privacy is challenging. Protected health information (PHI) and personally identifiable information (PII) must be masked before datasets can be used. This can be difficult for edge cases having potentially sensitive terms. However, existing rule-based algorithms and machine learning methods often incorrectly assess edge cases, thereby risking privacy violations.

### SUMMARY

According to an embodiment of the present invention, a computer system comprises a processor set, one or more computer-readable storage media, and program instructions stored on the one or more computer-readable storage media. The system detects, via a plurality of models, sensitive information within a dataset. The plurality of models includes detection models each configured for detecting the sensitive information within the dataset based on a different detection technique and evaluation models configured for producing evaluations of the detection models with respect to detecting the sensitive information. A resulting detection is generated from determinations of the detection models based on a consensus of the evaluations of the detection models. Performance of the plurality of models is evaluated and modifications for the plurality of models are determined based on the performance. The plurality of models are adjusted for detection of the sensitive information in accordance with the modifications. Embodiments of the present invention further include a method and computer program product for detecting sensitive information in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is block diagram of an architecture for detecting sensitive information according to an embodiment of the present invention.

FIG. 3 is a block diagram of a detection module of the architecture according to an embodiment of the present invention.

FIG. 4 is a flow diagram of a manner of evaluating detection of sensitive information according to an embodiment of the present invention.

FIG. 5 is a flow diagram of a manner of adjusting the detection module of the architecture according to an embodiment of the present invention.

FIG. 6 is a flow diagram of an example of detecting sensitive information according to an embodiment of the present invention.

### DETAILED DESCRIPTION

Current approaches for PHI/PII detection often struggle with accuracy due to their reliance on either rule-based algorithms or machine learning models trained on specific datasets. Consequently, these approaches fail to account for all edge cases, leading to missed instances of PHI/PII. This oversight poses significant privacy risks to data owners.

Accordingly, an embodiment of the present invention provides a brain-inspired architecture including multiple layers of artificial intelligence (AI) agents. The embodiment identifies sensitive information (e.g., PHI, PII, etc.) more comprehensively, and also iteratively improves itself based on human feedback, thereby enhancing the privacy and usability of medical datasets. The brain-inspired multi-agent architecture combines multiple AI techniques in a critically reasoning, self-supervising system.

An embodiment of the present invention provides a brain-inspired multi-agent system for detecting sensitive information (e.g., PHI, PII, etc.) in medical or other records with high accuracy. The system includes a detection module with a network of artificial intelligence (AI) judges (or models) that analyze input data to identify sensitive information (e.g., PHI, PII, etc.). A first layer of judges includes various language models (LMs), rule-based models, and machine learning models, each with different strengths. A second layer of judges aggregates the first layer outputs and leverages the generative capabilities of large language models (LLMs) to critically reason about edge cases and discrepancies. The system specifically addresses edge cases through critical reasoning about potentially sensitive terms (e.g., disease names that could be personal names, “Crohn's disease”, etc.) and combinations of terms that collectively could reveal sensitive information (e.g., multiple location identifiers that together could identify a specific individual, etc.).

An assessment module evaluates the performance of the judges, a consensus mechanism employed by the second layer, and decides on fine-tuning or model replacement to optimize the system. An adjustment module incorporates human feedback and assessment module evaluations to guide iterative refinement of the detection module. Additionally, the adjustment module encodes and manages a regulatory framework (the system's belief) for sensitive information detection (e.g., PHI, PII, etc.) allowing the system to adapt to different regulatory environments (e.g., Health Insurance Portability and Accountability Act (HIPAA), General Data Protection Regulation (GDPR), etc.) by modifying selection rules that affect statistical sampling from distribution of outputs generated by the detection module. This enables fine-grained control over the AI system's output behavior to ensure compliance with specific regional or national regulations.

An embodiment of the present invention provides a multi-agent system for detecting sensitive information (e.g., PHI, PII, etc.) in medical records. The system comprises a detection module, an assessment module, and an adjustment module. The detection module includes a network of AI judges (or models), including a first layer of diverse models and a second layer of evaluators that critically analyze the first layer outputs. The first layer includes language models, rule-based models, and machine learning models, each designed to detect sensitive information (e.g., PHI, PII, etc.) from a different perspective. The second layer of the detection module uses generative language understanding to identify discrepancies, analyze context, and generate the final sensitive information detection output (e.g., PHI, PII, etc.).

The assessment module evaluates the performance of the detection module components and provides recommendations for improvement. The assessment module employs specialized evaluators for different aspects of system performance including model performance assessors, consensus mechanism assessors, and system performance assessors which evaluate the detection module components and outputs. The model performance assessors analyze individual detection model accuracy, while the consensus mechanism assessors evaluate and optimize the aggregation process. The system performance assessors track end-to-end detection effectiveness. Each assessor type produces specific recommendations for improvement, including fine-tuning suggestions, model replacement proposals, consensus mechanism improvements, and architectural change proposals.

The adjustment module incorporates human feedback and assessment module evaluations to guide iterative refinement of the detection module. The adjustment module ingests human feedback, analyzes failures, deploys improvements to the detection module based on the assessment module evaluations and external ground truth signals, and manages regulatory frameworks for sensitive information detection (e.g., PHI, PII, etc.). The adjustment module modifies selection rules that affect the statistical sampling of outputs of the detection module, thereby ensuring compliance with specific regulatory requirements. The adjustment module employs rule-based algorithms, deep learning models, large language models (LLMs) with regulation-specific prompts, and/or retrieval-augmented generation systems to represent different regulatory frameworks. The adjustment module implements regulatory frameworks through multiple complementary approaches, such as rule-based algorithms for clear regulatory requirements, deep learning models trained on regulation-specific datasets, large language models (LLMs) with regulation-specific prompts, and retrieval-augmented generation (RAG) systems accessing regulatory documentation. This multi-faceted approach ensures comprehensive regulatory compliance while maintaining flexibility for framework updates.

An embodiment of the present invention adapts a multi-agent system for sensitive information detection (e.g., PHI, PII, etc.) to different regulatory environments. The multi-agent system includes a detection module, an assessment module, and an adjustment module as described above. The present invention embodiment encodes a specific regulatory framework (e.g., HIPAA, GDPR, etc.) into the adjustment module. Selection rules are modified to influence the output sampling of the detection module. The decision-making process of the adjustment module is adjusted based on the encoded regulatory framework. The encoded framework is continuously updated as regulations evolve or change.

Present invention embodiments provide several advantages. For example, the diversity of judges (or models) and layered critical reasoning maximize the chance of identifying all sensitive information (e.g., PHI, PII, etc.) even in challenging edge cases, thereby improving accuracy. The edge cases may include potentially sensitive terms (e.g., name of person used in a disease, etc.) and/or terms that collectively can be used to derive sensitive information (e.g., a street name, landmark, etc. may collectively be used to derive sensitive location information, etc.). The adjustment module allows the system to learn from its mistakes and improve over time based on human feedback, thereby providing adaptability. The detection module, assessment module, and adjustment module can be independently optimized or replaced, enabling flexible refinement and providing modularity. Further, by capturing when and why judges (or models) differ and which sensitive information categories (e.g., PHI, PII, etc.) pose challenges, the system offers insight into its decision-making process and provides explainability. The architecture of present invention embodiments is generalizable and domain-agnostic, and could be applied to various sensitive data masking tasks. Moreover, the ability of the adjustment module to encode and manage different regulatory frameworks (e.g., HIPAA, GDPR, etc.) allows the system to be easily adapted to various privacy regulations without requiring a complete overhaul of the AI components, thereby providing regulatory flexibility. This makes the system globally applicable and future-proof against evolving privacy regulations.

In addition, by minimizing the risk of privacy breaches, present invention embodiments enable wider leverage of medical datasets for research, thereby unlocking new healthcare insights. More broadly, present invention embodiments provide a class of brain-inspired AI systems that can reason critically about their own performance and adapt based on feedback, thereby offering a powerful framework for navigating complex, high-stakes data challenges across industries.

According to an aspect of the invention, a method comprises detecting, via a plurality of models of at least one processor, sensitive information within a dataset. The plurality of models includes detection models each configured for detecting the sensitive information within the dataset based on a different detection technique and evaluation models configured for producing evaluations of the detection models with respect to detecting the sensitive information. The at least one processor generates a resulting detection from determinations of the detection models based on a consensus of the evaluations of the detection models. The at least one processor evaluates performance of the plurality of models and determines modifications for the plurality of models based on the performance. The at least one processor adjusts the plurality of models for detection of the sensitive information in accordance with the modifications.

The diversity of the detection models and layered critical reasoning maximize the chance of identifying all sensitive information (e.g., PHI, PII, etc.) even in challenging edge cases, thereby improving accuracy. Further, the process learns from its mistakes and improves over time (based on human feedback), thereby providing adaptability.

In embodiments, the detection models include two or more from a group of language models, rule-based models, and machine learning models. The diversity of models and layered critical reasoning maximize the chance of identifying all sensitive information (e.g., PHI, PII, etc.) even in challenging edge cases, thereby improving accuracy.

In embodiments, the evaluation models include large language models. The layered critical reasoning maximizes the chance of identifying all sensitive information (e.g., PHI, PII, etc.) even in challenging edge cases, thereby improving accuracy.

In embodiments, the modifications include one or more from a group of fine-tuning at least one model of the plurality of models, replacing at least one model of the plurality of models, and modifying determination of the consensus. The process learns from its mistakes and improves over time, thereby providing adaptability. The various models can be independently optimized or replaced, enabling flexible refinement and providing modularity.

In embodiments, evaluating performance of the plurality of models comprises evaluating, via one or more machine learning models, performance of the detection models, determination of the consensus, and overall sensitive information detection. The process learns from its mistakes and improves over time, thereby providing adaptability.

In embodiments, the method further comprises modifying, via the at least one processor, selection rules that affect sampling for the resulting detection. The process learns from its mistakes and improves over time, thereby providing adaptability.

In embodiments, the method further comprises: encoding, via the at least one processor, a regulatory framework specifying handling of the sensitive information; modifying, via the at least one processor, selection rules that affect sampling for the resulting detection; modifying, via the at least one processor, selection of the modifications for the plurality of models based on the encoded regulatory framework; and updating, via the at least one processor, the encoded regulatory framework as the regulatory framework changes over time. This enables the process to be generalizable and domain-agnostic, and could be applied to various sensitive data masking tasks. Moreover, the ability to encode and manage different regulatory frameworks (e.g., HIPAA, GDPR, etc.) enables easy adaptation to various privacy regulations without requiring a complete overhaul of the AI components, thereby providing regulatory flexibility. This enables the process to be globally applicable and future-proof against evolving privacy regulations.

According to an aspect of the invention, a computer system comprises a processor set, one or more computer-readable storage media, and program instructions stored on the one or more computer-readable storage media. The processor set detects, via a plurality of models, sensitive information within a dataset. The plurality of models includes detection models each configured for detecting the sensitive information within the dataset based on a different detection technique and evaluation models configured for producing evaluations of the detection models with respect to detecting the sensitive information. The processor set generates a resulting detection from determinations of the detection models based on a consensus of the evaluations of the detection models. The processor set evaluates performance of the plurality of models and determines modifications for the plurality of models based on the performance. The processor set adjusts the plurality of models for detection of the sensitive information in accordance with the modifications.

The diversity of the detection models and layered critical reasoning maximize the chance of identifying all sensitive information (e.g., PHI, PII, etc.) even in challenging edge cases, thereby improving accuracy. Further, the system learns from its mistakes and improves over time (based on human feedback), thereby providing adaptability.

In embodiments of the computer system, the detection models include two or more from a group of language models, rule-based models, and machine learning models. The diversity of models and layered critical reasoning maximize the chance of identifying all sensitive information (e.g., PHI, PII, etc.) even in challenging edge cases, thereby improving accuracy.

In embodiments of the computer system, the evaluation models include large language models. The layered critical reasoning maximizes the chance of identifying all sensitive information (e.g., PHI, PII, etc.) even in challenging edge cases, thereby improving accuracy.

In embodiments of the computer system, the modifications include one or more from a group of fine-tuning at least one model of the plurality of models, replacing at least one model of the plurality of models, and modifying determination of the consensus. The system learns from its mistakes and improves over time, thereby providing adaptability. The various models can be independently optimized or replaced, enabling flexible refinement and providing modularity.

In embodiments of the computer system, evaluating performance of the plurality of models comprises evaluating, via one or more machine learning models, performance of the detection models, determination of the consensus, and overall sensitive information detection. The system learns from its mistakes and improves over time, thereby providing adaptability.

In embodiments of the computer system, the processor set further performs operations comprising: encoding a regulatory framework specifying handling of the sensitive information; modifying selection rules that affect sampling for the resulting detection; modifying selection of the modifications for the plurality of models based on the encoded regulatory framework; and updating the encoded regulatory framework as the regulatory framework changes over time. This enables the system to be generalizable and domain-agnostic, and could be applied to various sensitive data masking tasks. Moreover, the ability to encode and manage different regulatory frameworks (e.g., HIPAA, GDPR, etc.) enables easy adaptation to various privacy regulations without requiring a complete overhaul of the AI components, thereby providing regulatory flexibility. This enables the system to be globally applicable and future-proof against evolving privacy regulations.

According to an aspect of the invention, a computer program product comprises one or more computer-readable storage media, and program instructions stored on the one or more computer-readable storage media to perform operations. The program instructions detect, via a plurality of models, sensitive information within a dataset. The plurality of models includes detection models each configured for detecting the sensitive information within the dataset based on a different detection technique and evaluation models configured for producing evaluations of the detection models with respect to detecting the sensitive information. The program instructions generate a resulting detection from determinations of the detection models based on a consensus of the evaluations of the detection models. The program instructions evaluate performance of the plurality of models and determine modifications for the plurality of models based on the performance. The program instructions adjust the plurality of models for detection of the sensitive information in accordance with the modifications.

The diversity of the detection models and layered critical reasoning maximize the chance of identifying all sensitive information (e.g., PHI, PII, etc.) even in challenging edge cases, thereby improving accuracy. Further, the process of the computer program product learns from its mistakes and improves over time (based on human feedback), thereby providing adaptability.

In embodiments of the computer program product, the detection models include two or more from a group of language models, rule-based models, and machine learning models. The diversity of models and layered critical reasoning maximize the chance of identifying all sensitive information (e.g., PHI, PII, etc.) even in challenging edge cases, thereby improving accuracy.

In embodiments of the computer program product, the evaluation models include large language models. The layered critical reasoning maximizes the chance of identifying all sensitive information (e.g., PHI, PII, etc.) even in challenging edge cases, thereby improving accuracy.

In embodiments of the computer program product, the modifications include one or more from a group of fine-tuning at least one model of the plurality of models, replacing at least one model of the plurality of models, and modifying determination of the consensus. The process of the computer program product learns from its mistakes and improves over time, thereby providing adaptability. The various models can be independently optimized or replaced, enabling flexible refinement and providing modularity.

In embodiments of the computer program product, evaluating performance of the plurality of models comprises evaluating, via one or more machine learning models, performance of the detection models, determination of the consensus, and overall sensitive information detection. The process of the computer program product learns from its mistakes and improves over time, thereby providing adaptability.

In embodiments of the computer program product, the program instructions further perform operations comprising modifying selection rules that affect sampling for the resulting detection. The process of the computer program product learns from its mistakes and improves over time, thereby providing adaptability.

In embodiments of the computer program product, the program instructions further perform operations comprising: encoding a regulatory framework specifying handling of the sensitive information; modifying selection rules that affect sampling for the resulting detection; modifying selection of the modifications for the plurality of models based on the encoded regulatory framework; and updating the encoded regulatory framework as the regulatory framework changes over time. This enables the process of the computer program product to be generalizable and domain-agnostic, and could be applied to various sensitive data masking tasks. Moreover, the ability to encode and manage different regulatory frameworks (e.g., HIPAA, GDPR, etc.) enables easy adaptation to various privacy regulations without requiring a complete overhaul of the AI components, thereby providing regulatory flexibility. This enables the process of the computer program product to be globally applicable and future-proof against evolving privacy regulations.

In an example scenario, an input may include text, such as “Mr. Crohn got Crohn's disease at the age of 26.” The text is processed by first layer judges (or models) each producing a different masked version of the input (indicating sensitive information) based on its specialty.

A second layer receives model outputs and reasons about the discrepancies (e.g., model 1 and model 3 may mask age, while model 2 may mask disease). The second layer further analyzes the context (e.g., a first instance of “Crohn” is a name, and the second instance of “Crohn” is a disease), and produces a final output (e.g., masked text, such as “Mr. [PII] got [PII] at the age of [PII].”).

The final output is assessed to produce evaluations. For example, the evaluations may indicate the type of sensitive information missed by the models (e.g., model 2 missed PII, model 1 and model 3 missed PHI, etc.), and the level of performance and any deficiencies (e.g., overall performance is good, but missed PHI, etc.). Improvements for the models are determined based on the evaluations. By way of example, the improvements may include fine-tuning or training the models on more examples (e.g., fine-tuning model 2 on more PII examples, etc.) and updating the reasoning of the second layer to handle similar cases. The improvements are fed back and implemented on the models.

Present invention embodiments may be applied to various scenarios. For example, the system can be specifically adapted for scenarios including electronic health record (EHR) processing for research, unstructured data governance across organizations, social media content moderation, and a multi-national healthcare data exchange. Each application leverages the core architecture while incorporating domain-specific requirements and regulations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

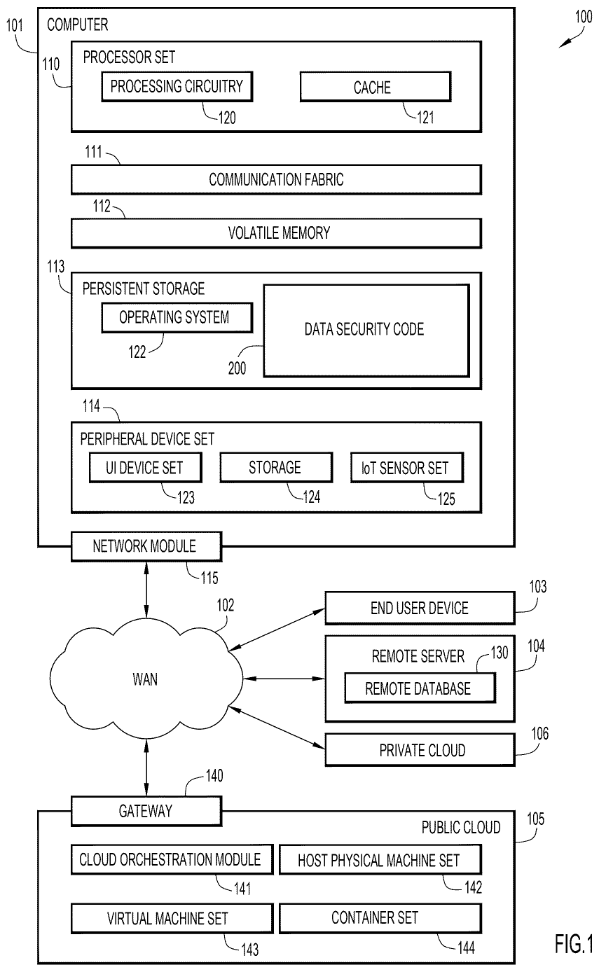

Referring to FIG. 1, computing environment 100 contains an example of an environment for the execution of at least some of the computer code involved in performing the inventive methods, such as data security code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): public and private clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offerings is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

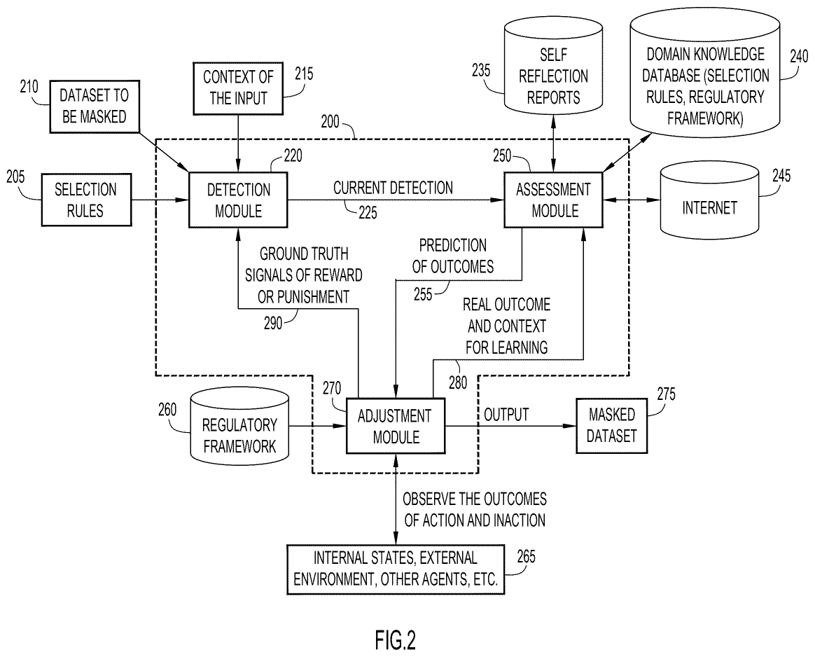

An architecture for detecting sensitive information according to an embodiment of the present invention is illustrated in FIG. 2. The architecture (of data security code 200) includes a detection module 220, an assessment module 250, and an adjustment module 270. Detection module 220 includes a network of AI judges (or models) that analyze input medical or other record data to identify sensitive information (e.g., PHI, PII, etc.). Detection module 220 receives selection rules 205 for identifying sensitive information, a dataset 210 (e.g., medical or other information to have sensitive information masked, etc.), and a context 215 for dataset 210, and detects sensitive information within the dataset. The selection rules provide rules for identifying sensitive information (e.g., rules indicating that certain items are sensitive information (e.g., a name, phone number, social security number, etc.), rules indicating certain items are not sensitive information). The selection rules may be used to detect sensitive information in accordance with a regulatory framework (e.g., HIPPA, GDPR, etc.), and control selection of detected sensitive information within a resulting output. The context may include, or be derived from, various information (e.g., healthcare provider notes, conversations with patients, etc.). The detection module provides a current or proposed detection 225 to assessment module 250 indicating the detected sensitive information. The current or proposed detection may be in the form of a masked dataset, where input terms of the dataset that are detected as sensitive information are masked (e.g., replaced with a mask or otherwise indicated as sensitive). The masking may use any indications or symbols.

Assessment module 250 includes a collection of AI models that evaluate performance of detection module 220 with respect to detecting sensitive information and determine how to optimize that performance. Assessment module 250 generates and/or utilizes information from self reflection reports 235, a domain knowledge database 240, and an external network 245 (e.g., the Internet, etc. for obtaining additional information). Self reflection reports 235 may include a history of performance results with respect to similar tasks and are produced by adjustment module 270. Domain knowledge database 240 contains information (e.g., the selection rules, regulatory framework, etc.) to provide further context. Assessment module 250 provides predictions of outcomes 255 (e.g., for changes or improvements, etc.) to adjustment module 270. The predictions of outcomes is determined relative to the current detections from detection module 220 to improve performance of detections.

Adjustment module 270 monitors human feedback, diagnoses failures, implements improvements, and manages the regulatory framework that guides the AI system's belief about what constitutes sensitive information (e.g., PHI, PII, etc.). Adjustment module 270 receives regulatory framework information 260 (e.g., HIPPA, GDPR, other laws or regulations of countries, etc.) and observes outcomes of action and inaction (with respect to changes) based on various state/agent information 265 (e.g., internal states, external environment, agents, etc.). Adjustment module 270 generates real outcomes and contexts 280 for learning by assessment module 250. The adjustment module may provide a masked dataset 275 based on satisfactory confidence of performance of detection module 220 (and/or assessment module 250). Human review may be enabled to ascertain feedback pertaining to the detections and generate ground truth signals 290 of reward and punishment (e.g., training data for correct and incorrect detections, etc.) for adjustment or training of detection module 220 (e.g., reinforcement learning, etc.). For example, the adjustment module provides user interfaces for human experts to review masked outputs and flag any missed sensitive information. This feedback is analyzed to identify failure patterns and guide specific improvements to the detection models and consensus mechanism. Adjustment module 270 enables the overall architecture to learn, improve continuously, and adapt to different regulatory environments.

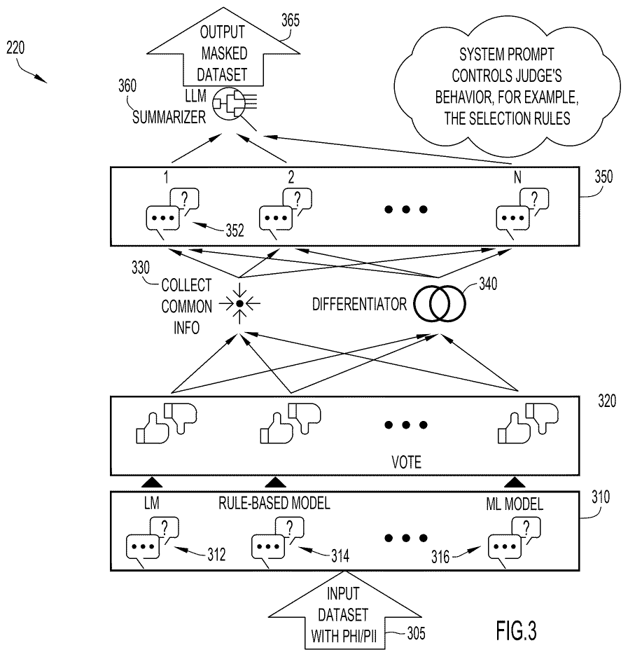

A block diagram of detection module 220 according to an embodiment of the present invention is illustrated FIG. 3. Detection module 220 includes a network of AI judges (or models) that analyze input medical or other record data to identify sensitive information (e.g., PHI, PII, etc.). The detection module includes a detection layer 310 with a diverse set of AI models to detect sensitive information (e.g., PHI, PII, etc.) and an evaluation layer 350 to evaluate the detections. The detection layer models process an input dataset in parallel to detect or identify sensitive information, while the evaluation layer aggregates detection layer outputs pertaining to those detections and reasons about discrepancies in the outputs that are used to produce a final sensitive information (e.g., PHI, PII, etc.) masked output. The masked output may include the input dataset with items detected as sensitive information being masked or otherwise indicated as being sensitive.

Detection layer 310 includes a diverse set of AI models each designed with a specialty or strength to detect sensitive information (e.g., PHI, PII, etc.) from a different perspective. For example, detection layer 310 may include one or more language models (LMs) 312, one or more rule-based models 314, and/or one or more machine learning models 316. However, the detection layer may include any quantity of any models detecting sensitive information.

LMs 312 may include any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.), preferably fine-tuned for named entity recognition (NER) to identify personal names, locations, ages, etc. By way of example, an LM 312 may employ any conventional or other large language model (LLM) and natural language processing (NLP) techniques to identify sensitive information within a dataset. These technologies can parse and understand the text and identify key elements. The large language model (LLM) receives a prompt or natural language instruction and a dataset, and processes the prompt to identify sensitive information in the dataset. The prompt may include several variations and forms. By way of example, the information in a prompt preferably includes an instruction to identify sensitive information and indicate selection rules, and the relevant dataset to analyze. For example, a Bidirectional Encoder Representations from Transformers (BERT) model may be used for named entity recognition (NER).

Rule-based models 314 may include any conventional or other models that employ heuristic algorithms that match or identify patterns or formats corresponding to items of sensitive information. The patterns may be indicated by regular expressions. For example, dates may may have a pattern of MM-DD-YYYY, phone numbers may have a pattern of XXX-XXX-XXXX, social security numbers may have a pattern of XXX-XX-XXX, etc. These patterns may be detected to identify the corresponding sensitive information. Rule-based models 314 may include any quantity of any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), etc.) trained to identify the patterns. By way of example, rule-based models 314 may include neural networks that are trained to identify the patterns in substantially the same manner described below.

Machine learning models 316 may include any quantity of any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), etc.). Machine learning models 316 may include classifiers trained on annotated medical or other records to detect sensitive medical terms and patient characteristics. For example, convolutional neural networks may be employed for identifying sensitive medical terms.

By way of example, neural networks may include an input layer, one or more intermediate layers (e.g., including any hidden layers), and an output layer. Each layer includes one or more neurons, where the input layer neurons receive input (e.g., data or features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various example data, features, and/or information as input (e.g., text, etc.) and corresponding desired outputs or classes (e.g., a class indicating sensitive information, a class indicating not sensitive information, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output or class (e.g., a class indicating sensitive information, a class indicating not sensitive information, etc.). The output with the highest probability may be selected as the result.

Each model of detection layer 310 receives and processes an input dataset 305 independently and produces a prediction 320 indicating whether or not information in input dataset 305 is sensitive (e.g., PHI, PII, etc.). The prediction may be provided in the form of a predicted sensitive information mask (e.g., the input dataset with sensitive information being masked or otherwise indicated as sensitive, etc.).

Evaluation layer 350 includes one or more large language models (LLMs) 352 that receive the original data and predictions 320 from models of detection layer 310. LLMs 352 may include any conventional or other large language models (LLMs), such as the LLMs described above, and may be fine-tuned on medical or other domain knowledge and sensitive information detection tasks. For example, LLMs 352 may include various conventional LLMs (e.g., GPT-4, Llama, Granite, etc.). LLMs 352 use their generative language understanding capabilities to identify discrepancies and edge cases where the models of the detection layer disagree and reason about the context to determine which models of detection layer 310 are likely correct. By way of example, LLMs 352 may be able to identify terms that collectively (or in combination) may be used to derive sensitive information (e.g., quasi-identifiers, etc.). An overall indication of sensitive information is produced from LLMs 352 based on analysis and a consensus mechanism.

Detection module 220 collects common information from predictions 320 of the different models of detection layer 310, and identifies discrepancies 340 between the predictions. LLMs 352 of evaluation layer 350 use their generative language understanding capabilities to identify discrepancies and edge cases where the models of the detection layer disagree and reason about the context to determine which models of detection layer 310 are likely correct. An LLM summarizer 360 generates an overall indication of sensitive information 365 (e.g., PHI/PII mask, etc.) from LLMs 352 based on analysis and the consensus mechanism. The LLM summarizer may include any quantity of any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), etc.). By way of example, LLM summarizer 360 may include a neural network as described above. The neural network may be trained using a training set of various example data, features, and/or information as input (e.g., various combinations of sensitive information indications, etc.) and corresponding desired outputs (e.g., resulting indication, etc.) in substantially the same manner described above.

Overall indication 365 serves as the final sensitive information (e.g., PHI, PII, etc.) detection result. The result may be in the form of a masked dataset (e.g., including the dataset with sensitive information masked or otherwise indicated as sensitive). The reasoning process also produces valuable metadata about model disagreements and uncertain cases.

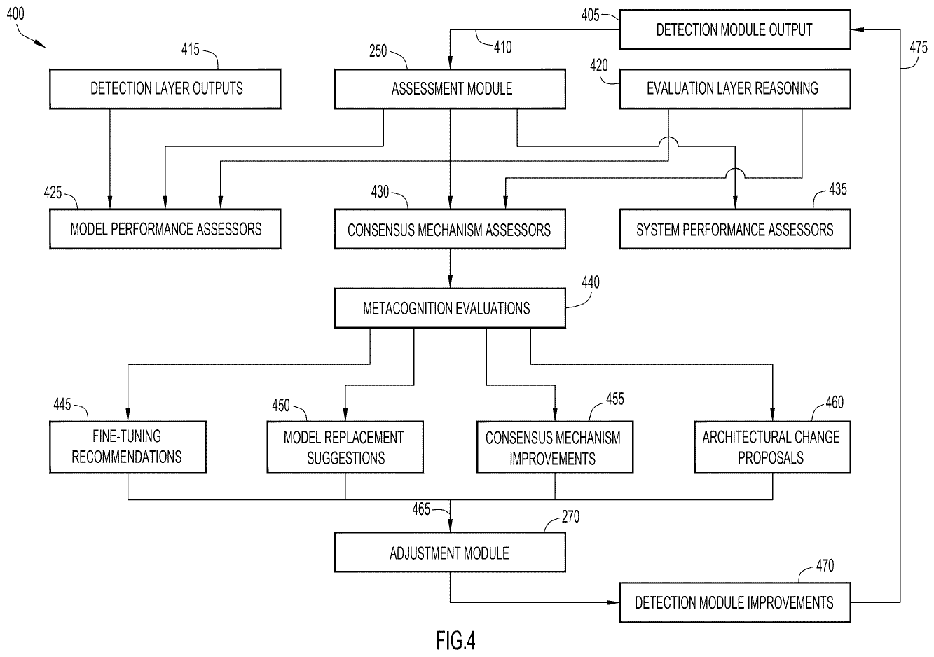

A method 400 of evaluating detection of sensitive information according to an embodiment of the present invention is illustrated in FIG. 4. Initially, assessment module 250 includes a collection of AI models that evaluate performance of detection module 220 and decide how to optimize that performance. The assessment module includes one or more model performance assessors 425, one or more consensus mechanism assessors 430, and one or more system performance assessors 435.

Output 405 from detection module 220 (e.g., resulting sensitive information detection, etc.) is provided to assessment module 250 at flow 410. The assessment module provides output 405 to model performance assessors 425, consensus mechanism assessors 430, and system performance assessors 435. Model performance assessors 425 further receive outputs of detection layer 310 of detection module 220 and reasoning information 420 from evaluation layer 350 of detection module 220. Model performance assessors include one or more machine learning models that analyze outputs of each LLM 352 of evaluation layer 350, compares the outputs to the final mask (or output 405) and human feedback to compute accuracy metrics (e.g., percentage of correct/incorrect detections, etc.). Basically, the model performance assessors identify low-performing LLMs 352 that may need fine-tuning or replacement (e.g., based on a comparison of the accuracy metrics to corresponding thresholds, etc.).

Model performance assessors 425 may include any quantity of any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), etc.). By way of example, a model performance assessor may include a neural network as described above. The neural network may be trained using a training set of various example data, features, and/or information as input (e.g., various sensitive information indications, final outputs, human feedback, etc.) and corresponding desired outputs (e.g., accuracy metrics, suggested improvements, etc.) in substantially the same manner described above.

Consensus mechanism assessors 430 further receive reasoning information 420 from evaluation layer 350 and LLM summarizer 360 of detection module 220. Consensus mechanism assessors 430 include one or more machine learning models that evaluate the reasoning process of LLMs 352 of evaluation layer 350 and the overall consensus mechanism of LLM summarizer 360 between LLMs 352 (e.g., voting, confidence weighting, etc.). The consensus mechanism assessors suggest improvements to an aggregation or consensus technique based on failure patterns.

Consensus mechanism assessors 430 may include any quantity of any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), etc.). By way of example, a consensus mechanism assessor may include a neural network as described above. The neural network may be trained using a training set of various example data, features, and/or information as input (e.g., various sensitive information indications, reasoning information, consensus mechanism information, etc.) and corresponding desired outputs (e.g., improvements to the consensus mechanism, etc.) in substantially the same manner described above.

System performance assessors 435 evaluate the overall performance of detection module 220. The system performance assessors include one or more machine learning models that track the end-to-end sensitive information detection performance and assess the impact of changes to detection module 220. The system performance assessors provide a high-level view to guide architectural decisions.

System performance assessors 435 may include any quantity of any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), etc.). By way of example, a system performance assessor may include a neural network as described above. The neural network may be trained using a training set of various example data, features, and/or information as input (e.g., various sensitive information indications of the detection and evaluation layers, reasoning information, etc.) and corresponding desired outputs (e.g., performance metrics, suggested improvements, etc.) in substantially the same manner described above.

Model performance assessors 425, consensus mechanism assessors 430, and system performance assessors 435 each produce metacognition evaluations 440 (based on outputs of the machine learning models). The metacognition evaluations include fine-tuning recommendations 445, model replacement suggestions 450, consensus mechanism improvements 455, and architectural change proposals 460.

The evaluations produced by model performance assessors 425, consensus mechanism assessors 430, and system performance assessors 435 are monitored by adjustment module 270 at flow 465. The adjustment module determines whether and which implementation of improvements 470 for detection module 220 should be triggered based on observation from external ground truth signals and environment changes.

Adjustment module 270 may include any quantity of any conventional or other machine learning models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), etc.). By way of example, adjustment module 270 may include a neural network as described above. The neural network may be trained using a training set of various example data, features, and/or information as input (e.g., various combinations of recommendations, etc.) and corresponding desired outputs (e.g., improvements to deploy, etc.) in substantially the same manner described above.

Detection module improvements 470 are implemented into detection module 220 at flow 475, thereby completing the learning loop.

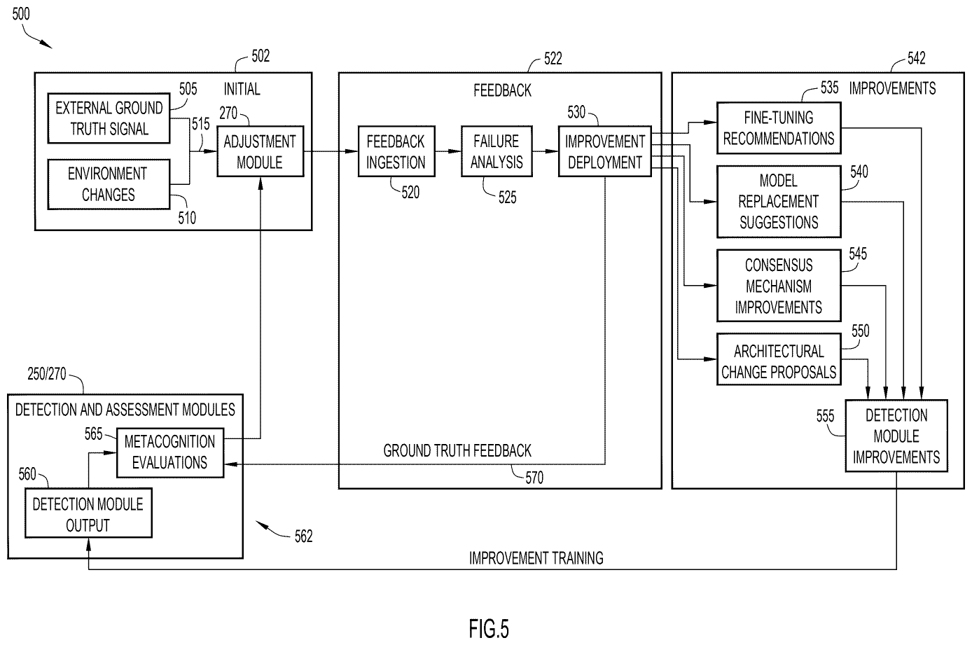

A method 500 of adjusting the detection module of the architecture according to an embodiment of the present invention is illustrated in FIG. 5. Initially, adjustment module 270 is responsible for monitoring human feedback, diagnosing failures, implementing improvements, and managing the regulatory framework that guides the AI system's belief about what constitutes sensitive information (e.g., PHI, PII, etc.). Adjustment module 270 determines improvements or adjustments in plural phases, including an initial phase 502, a feedback phase 522, an improvement phase 542, and an implementation phase 562.

In initial phase 502, adjustment module 270 receives and monitors an external ground truth signal 505 (e.g., accurate detections of sensitive information, feedback, etc.) and environment changes 510 at flow 515.

In feedback phase 522, adjustment module 270 performs feedback ingestion at flow 520 to process received feedback information concerning accuracy of sensitive information detections and/or misses. The adjustment module may provide a user interface for users to review resulting masked data from sensitive information detection and identify or flag any missed sensitive information (e.g., PHI, PII, etc.). The feedback from users is logged and aggregated. Further, the ingested feedback undergoes failure analysis at flow 525 to identify areas for improvement. For example, when user feedback indicates missed sensitive information, adjustment module 270 retrieves the relevant outputs from the models of detection layer 310, reasoning traces of LLMs 352 of evaluation layer 350 and LLM summarizer 360, and evaluations from assessment module 250. The retrieved information is analyzed to pinpoint or identify the source of the failure (e.g., a specific model of detection layer 310, an edge case not covered by the training data, etc.).

Based on the failure analysis (and recommendations from assessment module 250), adjustment module 270 determines the appropriate improvement deployment strategy at flow 530 for improvements phase 542. The improvement deployment strategy may include various recommendations or suggestions from assessment module 250 (e.g., fine-tuning recommendations 535, model replacement suggestions 540, consensus mechanism improvements 545, and/or architectural change proposals 550). Fine-tuning recommendations 535 may include fine-tuning models of detection layer 310 on adjusted training data, while model replacement suggestions 540 may include swapping in new models for detection layer 310. Consensus mechanism improvements 545 may include modifying the consensus mechanism for LLM summarizer 360.

Architecture change proposals 550 may pertain to regulatory framework management, selection rule management, adaptive sampling, framework switching, and regulatory updates. Adjustment module 270 may provide regulatory framework management by encoding and managing different regulatory frameworks (e.g., HIPAA, GDPR, etc.) in various manners. The regulatory frameworks may be encoded or formatted in any fashion. For example, the different regulatory frameworks may be managed by rule-based algorithms coded using classical or other programming techniques, deep learning models trained on regulation-specific datasets, large language models (LLMs) fine-tuned with regulation-specific prompts, and/or retrieval-augmented generation (RAG) systems that can access and interpret regulatory documents.

Selection rule management may be accomplished by adjustment module 270 managing selection rules 205 that influence how models of detection layer 310 of detection module 220 judge and sample from its distribution of potential outputs (e.g., determine which outputs from the models to utilize to produce the resulting output). These rules act as a filter, ensuring that the final output aligns with the encoded regulatory framework.

Adjustment module 270 may provide adaptive sampling by modifying the statistical sampling process of the AI system based on a current regulatory framework and the selection rules. This affects which potential sensitive information (e.g., PHI, PII, etc.) identifications are more likely to be selected as final outputs.

Framework switching may be accomplished by adjustment module 270 including mechanisms to smoothly transition between different regulatory frameworks. This allows quick adaptation for use in different countries or regions without requiring retraining of core AI models.

Adjustment module 270 may provide regulatory updates by employing user interfaces for updating the encoded frameworks as privacy regulations evolve. This can involve retraining models, updating rule sets, or refining LLM prompts based on new regulatory guidelines.

Through this iterative process of assessment, adjustment, and regulatory management, adjustment module 270 enables the overall architecture to learn, improve continuously, and adapt to different regulatory environments.

The selected improvement strategies described above are implemented as detection module improvements 555. The adjustment module tracks the changes and their impact on subsequent feedback.

In implementation phase 562, detection module improvements are applied to adjust detection module output at flow 560. Ground truth signals (e.g., accurate sensitive information detections, feedback, etc.) are also fed back to assessment module 250 for improving metacognition evaluations at flow 565. The detection module output and metacognition evaluations are provided to adjustment module 270 for flow 515 to perform the next iteration of learning. The iterative process ensures continuous improvement based on the metacognition evaluations from assessment module 250 and the feedback received by adjustment module 270. The adjustment module monitors the system's performance, analyzes failures, and deploys necessary improvements to detection module 220.

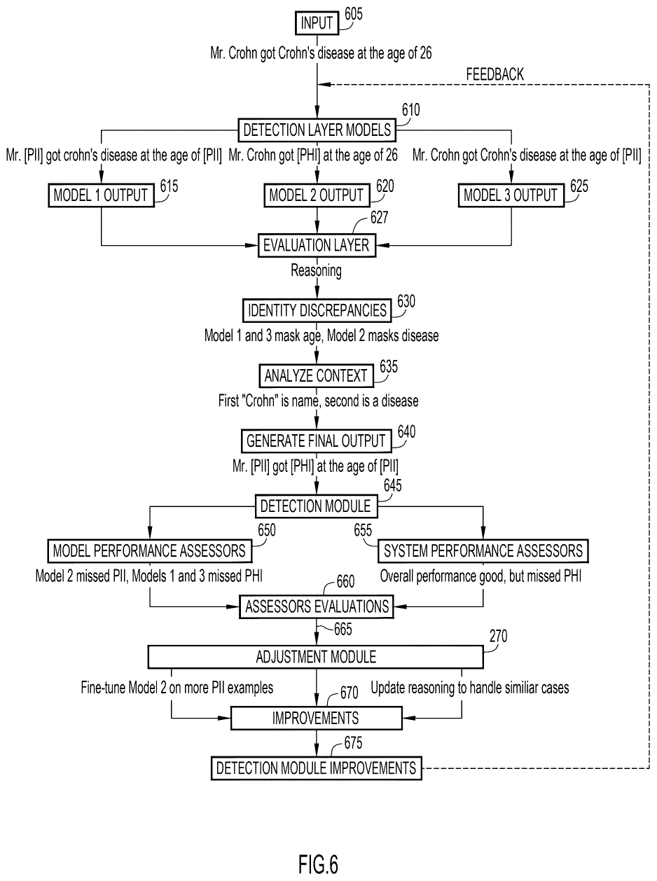

An example of detecting sensitive information according to an embodiment of the present invention is illustrated in FIG. 6. Initially, an input dataset is received at flow 605. By way of example, the input dataset may include text, such as “Mr. Crohn got Crohn's disease at the age of 26.” The text is processed by models of detection layer 310 of detection module 220 at flow 610 in substantially the same manner described above. Each model produces a different masked version of the input (indicating sensitive information) based on its strength or specialty. For example, the detection layer may include first, second, and third models each producing an output indicating detection of sensitive information based on the text (e.g., model 1 output 615, model 2 output 620, and model 3 output 625 as viewed in FIG. 6).

Evaluation layer 350 receives model outputs 615, 620, 625 at flow 627 and reasons about the discrepancies at flow 630 (e.g., model 1 and model 3 may mask age, while model 2 masks disease). The evaluation layer further analyzes the context at flow 635 (e.g., a first instance of “Crohn” is a name, and the second instance of “Crohn” is a disease), and produces a final output 645 (e.g., masked text) for detection module 220 at flow 640 (e.g., “Mr. [PII] got [PII] at the age of [PII].”).

Final output 645 is assessed by model performance assessors of assessment module 250 at flow 650 and by system performance assessors of assessment module 250 at flow 655 to produce assessor evaluations at flow 660. For example, the model performance assessors may provide an evaluation indicating the type of sensitive information missed by the models (e.g., model 2 missed PII, model 1 and model 3 missed PHI, etc.), while the system performance assessors may provide an evaluation indicating the level of performance and any deficiencies (e.g., overall performance is good, but missed PHI, etc.).

Adjustment module 270 receives the assessor evaluations at flow 665 and determines improvements 670 for detection module 220. By way of example, the improvements may include fine-tuning or training models of detection layer 310 on more examples (e.g., fine-tuning model 2 on more PII examples, etc.) and updating the reasoning of LLMs 352 of evaluation layer 350 to handle similar cases. The improvements are fed back at flow 675 and implemented on the models of detection layer 310 of flow 610 to continue the feedback loop for future input processing.

An embodiment of the present invention may be used to detect sensitive information for various applications or scenarios. For example, an embodiment of the present invention may be used to detect sensitive information in electronic health records (EHRs). The multi-agent system described above may be configured for detecting sensitive information (e.g., PHI, PII, etc.) in electronic health records. Initially, AI models of detection layer 310 are trained or configured for diverse approaches (e.g., Bidirectional Encoder Representations from Transformers (BERT) for named entity recognition, regular expressions for pattern matching, convolutional neural networks for identifying sensitive medical terms, etc.). Conventional or other large language models (LLMs) (e.g., GPT-4, Llama, Granite, etc.) are fine-tuned on medical domain knowledge and sensitive information detection tasks and are used for evaluation layer 350.

Assessment module 250 is configured to employ machine learning models to evaluate the performance of individual models of the detection layer, the consensus mechanism, and the overall system. Adjustment module 270 is integrated with a human-in-the-loop interface for domain experts to provide feedback on the system's outputs and guide improvements. The system may be deployed as a middleware service that can process EHRs in real-time, masking sensitive information (e.g., PHI, PII, etc.) before sharing data for research or analysis.

An embodiment of the present invention may be used for unstructured data governance. The multi-agent system described above may be configured or adapted for detecting sensitive information (e.g., PHI, PII, etc.) in unstructured data across an organization (e.g., emails, documents, chat logs, etc.). The AI models of detection layer 310 are trained on organization-specific data and policies to identify confidential information, intellectual property, and personal data (e.g., as defined by regulations, such as GDPR, HIPAA, etc.). The system is integrated with data governance tools and workflows to automatically classify, mask, and/or redact sensitive information before data is shared or stored. Adjustment module 270 incorporates feedback from data stewards and compliance officers to continuously improve the system's accuracy and coverage.

An embodiment of the present invention may be used for social media content moderation. The multi-agent system described above may be configured or adapted for detecting and masking sensitive information (e.g., personal information, disrespectful speech, other sensitive content, etc.) in user-generated posts and comments on social media platforms. The AI models of detection layer 310 are trained on platform-specific policies and community guidelines to identify problematic content. The LLMs of evaluation layer 350 analyze the context and nuances of the content to reduce false positives and false negatives. Adjustment module 270 is integrated with human moderators to provide feedback on the system's decisions and handle appeals or edge cases. The system may be deployed as part of the platform's content moderation pipeline to automatically flag, mask, or remove sensitive content in real-time.

These embodiments demonstrate the versatility and potential impact of the multi-agent system for detecting and masking sensitive information across various domains, from healthcare to data governance to social media. The modular architecture and continuous learning loop enable the system to adapt to specific use cases and improve over time based on human feedback and evolving requirements.

An embodiment of the present invention may be used for a multi-national health care data exchange. The multi-agent system described above may be configured or adapted with an enhanced adjustment module to facilitate secure, compliant sharing of medical data across healthcare institutions in different countries. Multiple regulatory frameworks (e.g., HIPAA for the US, GDPR for the EU, PIPEDA for Canada, etc.) are encoded into adjustment module 270 using a combination of rule-based algorithms for clear-cut regulations, fine-tuned BERT models for nuanced text classification based on regulatory definitions, GPT-4 with carefully crafted prompts for each regulatory framework, and/or a RAG system using a knowledge base of regulatory documents and interpretations,

A user interface is developed that allows system administrators to select the appropriate regulatory framework within adjustment module 270 based on the data origin and destination. A dynamic selection rule system is implemented in the adjustment module that adjusts the detection module output sampling based on the active regulatory framework. A regulatory update pipeline is created within the adjustment module that allows for easy incorporation of new or changed regulations (e.g., automated scraping and processing of official regulatory documents, a human-in-the-loop verification system for interpreting new regulations, an A/B testing framework to validate the effectiveness of regulatory updates before full deployment, etc.).

The system may be integrated with existing health information exchange (HIE) networks, allowing the system to process and appropriately mask sensitive information (PHI, PII, etc.) in real-time as data is shared across borders. Comprehensive audit logs are developed that track which regulatory framework was applied to each data exchange, thereby ensuring transparency and facilitating compliance verification.

In this embodiment, the enhanced adjustment module enables the multi-agent system to adapt to complex, multi-national regulatory environments, thereby facilitating secure and compliant international healthcare data exchange.

It will be appreciated that the embodiments described above and illustrated in the drawings represent only a few of the many ways of implementing embodiments for detecting sensitive information via machine learning agents.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., data security code 200, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., detection results, feedback, datasets, performance metrics, improvements/changes, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., detection results, feedback, performance metrics, improvements/changes, etc.).

The present invention embodiments are not limited to the specific tasks or algorithms described above, but may be utilized for detecting sensitive or any other information desired to be maintained private within any dataset.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting, via a plurality of models of at least one processor, sensitive information within a dataset, wherein the plurality of models includes detection models each configured for detecting the sensitive information within the dataset based on a different detection technique and evaluation models configured for producing evaluations of the detection models with respect to detecting the sensitive information;
generating, via the at least one processor, a resulting detection from determinations of the detection models based on a consensus of the evaluations of the detection models;
evaluating, via the at least one processor, performance of the plurality of models and determining modifications for the plurality of models based on the performance; and
adjusting, via the at least one processor, the plurality of models for detection of the sensitive information in accordance with the modifications.

2. The method of claim 1, wherein the detection models include two or more from a group of language models, rule-based models, and machine learning models.

3. The method of claim 1, wherein the evaluation models include large language models.

4. The method of claim 1, wherein the modifications include one or more from a group of fine-tuning at least one model of the plurality of models, replacing at least one model of the plurality of models, and modifying determination of the consensus.

5. The method of claim 1, wherein evaluating performance of the plurality of models comprises:
evaluating, via one or more machine learning models, performance of the detection models, determination of the consensus, and overall sensitive information detection.

6. The method of claim 1, further comprising:
modifying, via the at least one processor, selection rules that affect sampling for the resulting detection.

7. The method of claim 1, further comprising:
encoding, via the at least one processor, a regulatory framework specifying handling of the sensitive information;
modifying, via the at least one processor, selection rules that affect sampling for the resulting detection;
modifying, via the at least one processor, selection of the modifications for the plurality of models based on the encoded regulatory framework; and
updating, via the at least one processor, the encoded regulatory framework as the regulatory framework changes over time.

8. A computer system comprising:
a processor set;
one or more computer-readable storage media; and
program instructions stored on the one or more computer-readable storage media to cause the processor set to perform operations comprising:
detecting, via a plurality of models, sensitive information within a dataset, wherein the plurality of models includes detection models each configured for detecting the sensitive information within the dataset based on a different detection technique and evaluation models configured for producing evaluations of the detection models with respect to detecting the sensitive information;
generating a resulting detection from determinations of the detection models based on a consensus of the evaluations of the detection models;
evaluating performance of the plurality of models and determining modifications for the plurality of models based on the performance; and
adjusting the plurality of models for detection of the sensitive information in accordance with the modifications.

9. The computer system of claim 8, wherein the detection models include two or more from a group of language models, rule-based models, and machine learning models.

10. The computer system of claim 8, wherein the evaluation models include large language models.

11. The computer system of claim 8, wherein the modifications include one or more from a group of fine-tuning at least one model of the plurality of models, replacing at least one model of the plurality of models, and modifying determination of the consensus.

12. The computer system of claim 8, wherein evaluating performance of the plurality of models comprises:
evaluating, via one or more machine learning models, performance of the detection models, determination of the consensus, and overall sensitive information detection.

13. The computer system of claim 8, wherein the operations further comprise:
encoding a regulatory framework specifying handling of the sensitive information;
modifying selection rules that affect sampling for the resulting detection;
modifying selection of the modifications for the plurality of models based on the encoded regulatory framework; and
updating the encoded regulatory framework as the regulatory framework changes over time.

14. A computer program product comprising:
one or more computer-readable storage media; and
program instructions stored on the one or more computer-readable storage media to perform operations comprising:
detecting, via a plurality of models, sensitive information within a dataset, wherein the plurality of models includes detection models each configured for detecting the sensitive information within the dataset based on a different detection technique and evaluation models configured for producing evaluations of the detection models with respect to detecting the sensitive information;
generating a resulting detection from determinations of the detection models based on a consensus of the evaluations of the detection models;
evaluating performance of the plurality of models and determining modifications for the plurality of models based on the performance; and
adjusting the plurality of models for detection of the sensitive information in accordance with the modifications.

15. The computer program product of claim 14, wherein the detection models include two or more from a group of language models, rule-based models, and machine learning models.

16. The computer program product of claim 14, wherein the evaluation models include large language models.

17. The computer program product of claim 14, wherein the modifications include one or more from a group of fine-tuning at least one model of the plurality of models, replacing at least one model of the plurality of models, and modifying determination of the consensus.

18. The computer program product of claim 14, wherein evaluating performance of the plurality of models comprises:
evaluating, via one or more machine learning models, performance of the detection models, determination of the consensus, and overall sensitive information detection.

19. The computer program product of claim 14, wherein the operations further comprise:
modifying selection rules that affect sampling for the resulting detection.

20. The computer program product of claim 14, wherein the operations further comprise:
encoding a regulatory framework specifying handling of the sensitive information;
modifying selection rules that affect sampling for the resulting detection;
modifying selection of the modifications for the plurality of models based on the encoded regulatory framework; and
updating the encoded regulatory framework as the regulatory framework changes over time.
